(19) United States
(12) Patent Application Publication
(10) Pub. No.: US 2003/0168486 A1
(43) Pub. Date: Sep. 11, 2003

(54) Novel vehicle drink holder

(76) Inventor: Paul F. Adams, Little Rock, AK (US)

Correspondence Address: OBERMAYER REBMANN MAXWELL & HIPPEL LLP, 1617 JOHN F KENNEDY BLVD, 19TH FLOOR, PHILIDELPHIA, PA, 19103, US

(21) Appl. No.: 10/094,150

(22) Filed: Mar. 8, 2002

(51) Int. Cl. B60R 7/00; B60R 9/00; B60R 11/00

(52) U.S. Cl. 224/482; 224/926

(57) ABSTRACT

The cup holder comprises a single modular unit, and comprises an attachment means and a downward extending cup support. In one embodiment, the invention comprises a singular molded polymer plastic, or other rigid polymeric material that, for example, may be thermoformed. The cup holder and support mechanism is designed to mold to and attach to the top interior paneling of a vehicle door directly below the window.

### FIELD OF THE INVENTION

The present invention relates, in general, to an accessory for holding drinking implements such as cups, cans and the like. In particular, the present invention is directed to cup holders and the like for use in automobiles, trucks, vans or RVs.

### BACKGROUND OF THE INVENTION

Cup, can and drink holders for the convenience of drivers of automobiles and the like are very popular and enhance the ability of the driver to access and drink beverages while driving. The existence and popularity of vehicle cup and drink holders increase the safety of driving while the driver is drinking non-alcoholic beverages. A number of vehicles have such drink holders built into the vehicle as standard equipment.

There have been a number of vehicle drink holders disclosed in the patent literature and prior art. U.S. Pat. No. 5,044,577, for example, discloses an automobile cup holder including an anchor and a holder body. The anchor includes a wedge element adjustably connected to the holder and adapted for insertion into the ashtray socket of the vehicle.

U.S. Pat. No. 5,086,958 similarly discloses a cup holder accessory mount also dimensioned for insertion into a cigarette lighter and including a flange to be attached to a cup.

U.S. Pat. No. 5,191,679 discloses a displaceable hinge for use in a vehicle for a beverage container. Other patents disclosing vehicle cup holders include U.S. Pat. Nos. 5,165,639; 5,165,646; and U.K. Patent Application 2,129,671A.

While there are a number of drink holders, none have been designed to affix to the interior of the door of vehicle and which are designed to conform to the molding of the door interior.

It would be desirable to provide a drink cup holder that could attach to the interior side of the vehicle door at the base of a window.

It would particularly be desirable to provide a drink cup holder that is molded for attachment to the interior side door panel of a car, truck, etc.

It would also be desirable to provide a cup holder which attaches to the interior of a car or vehicle door at the base of a window and which is specifically designed for use in a vehicle such as the Chevrolet Corvette.

It would be particularly desirable to have a cup holder that could be designed for application to all vehicles.

These and other objects of the present invention will become apparent from the summary and detailed description that follows.

### SUMMARY OF THE INVENTION

The present invention is directed to a cup and drink holder designed to attach to the interior side paneling of a vehicle door. In one embodiment, the cup and drink holder is designed for use in a Chevrolet Corvette.

In a preferred embodiment, the cup holder comprises a single modular unit and comprises an attachment means and a downward extending cup support. In one embodiment, the invention comprises a molded polymer plastic, or other rigid polymeric material that, for example, may be thermoformed. The cup holder and support mechanism is designed to mold to and attach to the top interior paneling of a vehicle door directly below the window.

These and other objects of the present invention will become more apparent from the following detailed description.

### BRIEF DESCRIPTION OF THE FIGURES

FIG. 1 is a perspective view of the vehicle cup holder of the present invention.

FIG. 2 is an overhead view of the vehicle cup holder of the present invention.

FIG. 3 is a side perspective view of the vehicle cup holder of the present invention.

FIG. 4 is a rear view of the vehicle cup holder of the present invention.

### DETAILED DESCRIPTION OF THE INVENTION

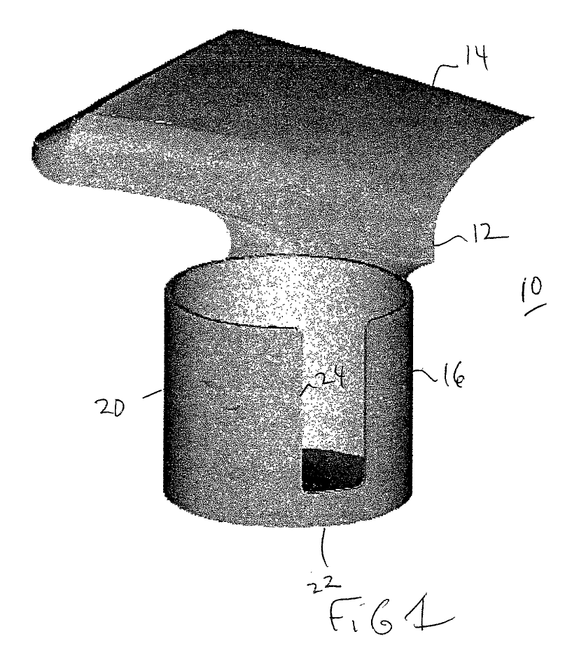

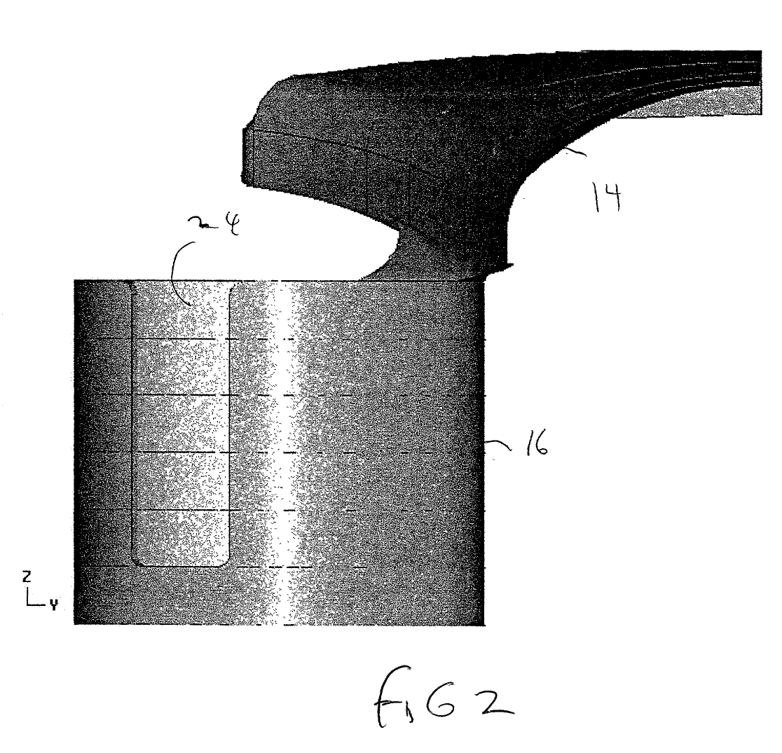

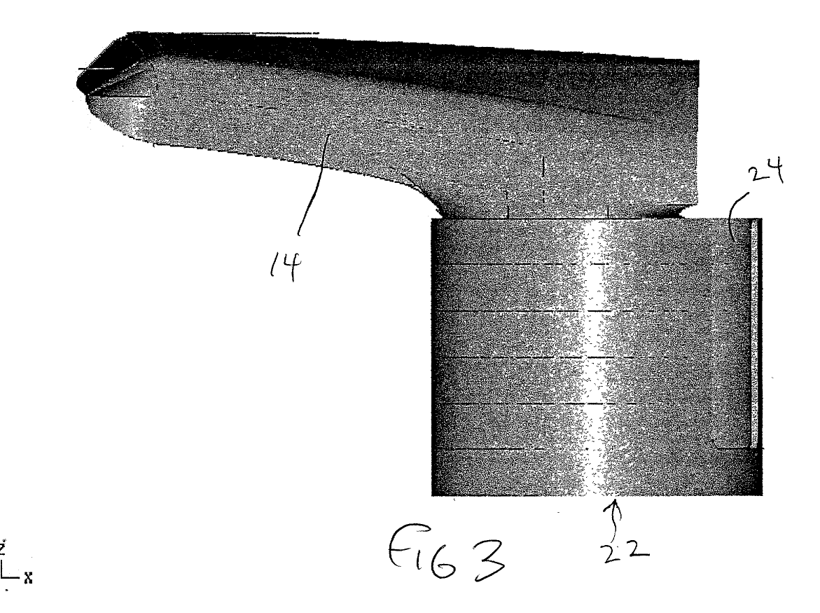

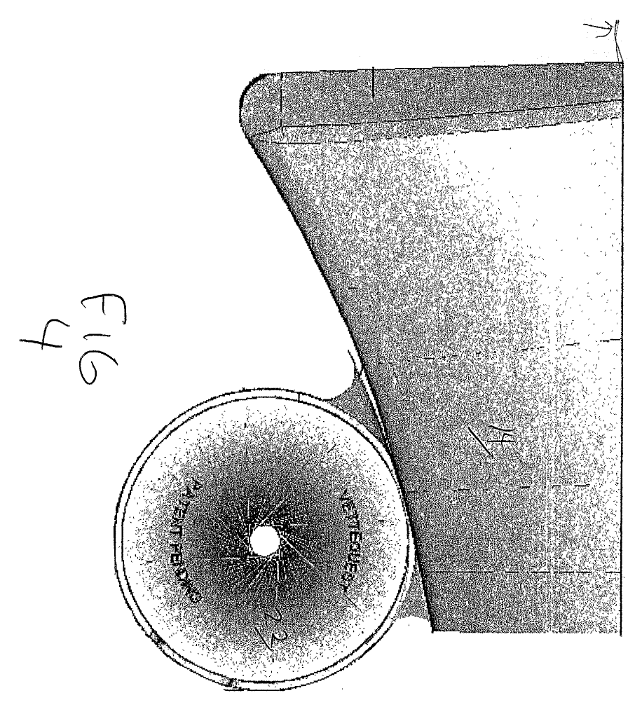

The present invention is now described with reference to the enclosed FIGS. 1 to 4 wherein the same numbers are used where applicable. The present invention comprises a cup holder 10, which is intended to fit on and mate with the interior molding of the door of a motor vehicle just below the window. For purposes of the present invention, the term motor vehicle means automobile, SUV, RV, truck, van and any other form of motorized vehicle including a door. In a most preferred embodiment, the motor vehicle is a Chevrolet Corvette. Moreover, for the purposes of this disclosure, the term “cup holder” is to be recognized as encompassing any device that supports a drinking cup, can or bottle.

The cup holder 10 comprises a single modular unit 12, and comprises an attachment means 14 and a downward extending cup support 16. In one embodiment, the invention comprises a singular molded polymer plastic, or other rigid polymeric material that, for example, may be thermoformed. The cup holder and support mechanism is designed to mold to and attach to the top interior paneling of a vehicle door directly below the window 18.

In one embodiment as shown in the Figures, the attachment means is 14 specifically designed to mold with and attach to the interior door paneling of a vehicle such as a Chevrolet Corvette. It is to be appreciated and readily understood that the teachings of the present invention are equally applicable to other vehicle designs in which the attachment means 14 can be designed to mold with the interior paneling of the vehicle door.

Extending downward substantially vertical from the attachment means 14 is the cup support 16 which comprises a cylindrical sleeve 20 having a bottom 22 which supports a drink such as a bottle or can. The cylindrical sleeve 20 includes a cut groove 24 that facilitates expansion of the drink holder and the use of the holder 10 with cups, bottles and like having varying diameters.

It is to be appreciated that other embodiments fulfill the spirit and scope of the present invention and the true nature of the scope of the invention is to be determined with reference to the claims to attached hereto.

1. A novel cup holder for a vehicle comprising a first molded member attached to a door panel of a vehicle:
a vertically downward extending cup attached to the molded member.

2. A novel cup holder for use in a Corvette comprising:
first member which overlays the passenger side or driver's side panel of said Corvette proximate to the window; and
a downward extending cup assembly attachment to the member for supporting a drinking cup.

3. A cup holder comprising:
a single modular unit comprising an attachment means and a downward extending cup support constructed of a singular molded polymer plastic or other rigid polymeric material.
